(19) United States
(12) Patent Application Publication
(10) Pub. No.: US 2006/0132876 A1
(43) Pub. Date: Jun. 22, 2006

(54) Image processing apparatus and method

(76) Inventor: Man-chan Kim, Suwon-si (KR)

Correspondence Address: STANZIONE & KIM, LLP, 919 18TH STREET, N.W., SUITE 440, WASHINGTON, DC, 20006, US

(21) Appl. No.: 11/294,419

(22) Filed: Dec. 6, 2005

(30) Foreign Application Priority Data
Dec. 16, 2004 (KR) 2004-107161

(51) Int. Cl. H04N 1/46

(52) U.S. Cl. 358/540

(57) ABSTRACT

An image processing apparatus and an image processing method. The image processing apparatus includes a cell information obtaining unit to obtain cell information of each of a plurality of cell images, the cell information including at least location information of each of the plurality of cell images, a cell image arranging unit to arrange the cell images according to the obtained cell information, and to generate at least one group image by grouping adjacent cell images together, and a group image processing unit to perform a predetermined image processing for each of the at least one group image.

### CROSS-REFERENCE TO RELATED APPLICATIONS

This application claims the priority under 35 U.S.C. §119 from Korean Patent Application No. 2004-107161, filed on Dec. 16, 2004 in the Korean Intellectual Property Office, the disclosure of which is incorporated herein in its entirety by reference.

### BACKGROUND OF THE INVENTION

1. Field of the Invention

The present general inventive concept relates to an image processing apparatus and, more particularly, to an image processing apparatus which creates cell images by dividing an image to be printed, groups adjacent cell images, and image-processes each of the groups of cell images, and an image processing method thereof.

2. Description of the Related Art

Most cameras and printers can perform predetermined image processing on given images. Image photographing apparatuses, such as cameras, or image forming apparatuses, such as printers, include image processing functions to enhance visual aesthetics to given images.

For example, many cameras include a white balancing function. White balancing is an image processing technique by which a photographed image can be brightened by slightly increasing the values of all pixels of the photographed image when the photographed image is dark.

In addition, such an image processing function can be included in image forming apparatuses like printers. Here, the image processing function applies the corresponding image processing to an entire given image that is printable on one page of a printing medium, and the image forming apparatuses print the entire image-processed image on the printing medium.

According to a conventional image processing apparatus, all the given images printable on a-page of a printing medium are image-processed as a single block. If the image processing technique corresponds to white balancing in a camera and white pixels exist among pixels that form the given images, the conventional image processing apparatus cannot apply the image-processing technique to the given images.

A technique of dividing an image into a plurality of cell images and then image-processing each of the cell images to print all of the cell images on a page of a printing medium has been suggested. However, since adjacent cell images are image-processed separately, an image formed by the adjacent cell images is unnatural when compared to the image before image processing.

### SUMMARY OF THE INVENTION

The present general inventive concept provides an image processing apparatus to group adjacent cell images created by dividing a predetermined entire image, and to apply image processing to each of the grouped cell images to print the entire image on a page of a printing medium, and an image processing method thereof.

The present general inventive concept also provides an image processing apparatus to generate a plurality of cell images by dividing an entire image, to group adjacent cell images after receiving the generated cell images, and to apply image processing to each of the grouped images to print the entire image on a page of a printing medium, and an image processing method thereof.

The present general inventive concept also provides a computer readably recording medium having executable codes recorded therein to perform an image processing method including grouping adjacent cell images created by dividing a predetermined entire image, and applying image processing to each of the grouped images to print the entire image on a page of a printing medium.

Additional aspects and advantages of the present general inventive concept will be set forth in part in the description which follows and, in part, will be obvious from the description, or may be learned by practice of the general inventive concept.

The foregoing and/or other aspects of the present general inventive concept are achieved by providing an image processing apparatus including a cell information obtaining unit to obtain cell information of each of a plurality of cell images, the cell information including at least location information of each of the plurality of cell images, a cell image arranging unit to arrange the cell images according to the obtained cell information, and to generate at least one group image by grouping adjacent cell images together; and a group image processing unit to perform a predetermined image processing for each group image generated.

The image processing apparatus may further include a printing unit to print all of the image-processed group images as one image on a page of a printing medium.

The cell information may further comprise size information of the cell images in an entire image.

The group image processing unit may change pixel values of all pixels included in the at least one group image without changing rankings in terms of sizes of the pixel values.

The group image processing unit may change a pixel value of a brightest pixel among all the pixels included in each group image generated into a white pixel value and changes a pixel value of a darkest pixel among all the pixels included in each group image generated into a black pixel value, and expands pixel values of all other pixels included in each group image generated based on the changes performed on the darkest pixel value and the brightest pixel value.

The foregoing and other aspects of the present general inventive concept may also be achieved by providing an image processing apparatus including a cell image generating unit to generate a plurality of cell images by dividing an entire image and to generate cell information including at least location information of each of the cell images, and a cell image processing unit to arrange the plurality of cell images according to the cell information, to generate at least one group image by grouping adjacent cell images together, and to perform a predetermined image processing for each of the at least one group image.

The cell image processing unit may include a cell information obtaining unit to obtain the cell information, a cell image arranging unit to arrange the plurality of cell images according to the obtained cell information, and to generate the at least one group image by grouping the adjacent cell images, and a group image processing unit to perfprm the predetermined image processing for each of the at least one group image.

The foregoing and other aspects of the present general inventive concept may also be achieved by providing an image processing method including obtaining cell information including at least location information of each of a plurality of cell images, arranging the plurality of cell images according to the obtained cell information and generating at least one group image by grouping adjacent cell images, and performing a predetermined image processing for each group image generated.

The method may further comprise printing all of the image-processed group images generated as one image on a page of a printing medium.

The foregoing and other aspects of the present general inventive concept may also be achieved by providing a computer readable storage medium containing executable codes to perform a method including obtaining cell information including at least location information of each of a plurality of cell images, arranging the plurality of cell images according to the obtained cell information and generating at least one group image by grouping adjacent cell images and performing a predetermined image processing for each of the at least one group image.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram of an image processing apparatus according to an embodiment of the present general inventive concept;

FIGS. 2A through 2C are reference diagrams illustrating a process of creating a group image according to an embodiment of the present general inventive concept;

FIGS. 3A and 3B are reference graphs illustrating image processing conducted by the image processing apparatus according to an embodiment of the present general inventive concept; and

FIG. 4 is a flow chart illustrating an image processing method according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

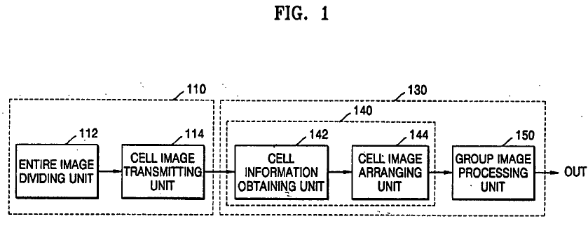

FIG. 1 is a block diagram of an image processing apparatus according to an embodiment of the present general inventive concept. The image processing apparatus includes a cell image generating unit 110 and a cell image processing unit 130.

The cell image generating unit 110 may include an entire image dividing unit 112 and a cell image transmitting unit 114. The cell image generating unit 110 divides a predetermined entire image into a plurality of cell images. Hereinafter, the entire image is printable on a page of a printing medium, and also, all of the cell images are printable on a page of a printing medium.

More specifically, the entire image dividing unit 112 can create the plurality of cell images, and the cell image transmitting unit 114 stores the created cell images and transmits the cell images to the cell image processing unit 130. The cell images created at the entire image dividing unit 112 have cell information including location information of the cell image in the entire image. The cell information may further include size information of the cell image.

The cell image processing unit 130 can include a grouping unit 140 and a group image processing unit 150. The grouping unit 140 can include a cell information obtaining unit 142 and a cell image arranging unit 144.

The cell information obtaining unit 142 obtains cell information on the plurality of cell images generated by the entire image dividing unit 112. The cell image arranging unit 144 arranges the plurality of cell images according to the obtained cell information and generates at least one group image. That is, the group image may be formed by grouping at least two adjacent cell images, or may consist of one cell image.

The grouping unit 140 may form one group image by grouping the plurality of cell images, and each of the cell images is included in a predetermined group image among the at least one group image.

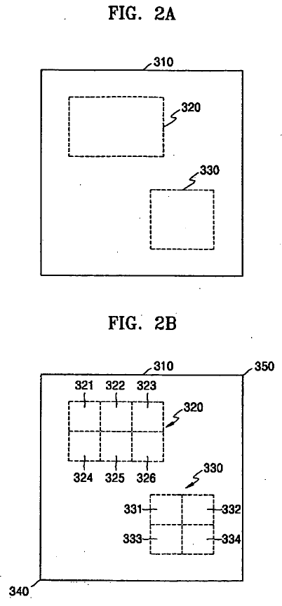

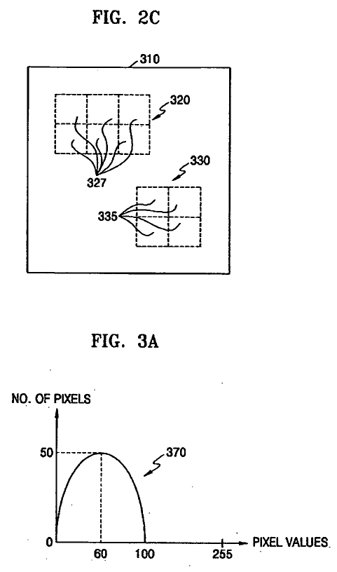

FIGS. 2A through 2C are reference diagrams illustrating a process performed by the grouping unit 140 to create a group image according to an embodiment of the present general inventive concept. FIG. 2A is an exemplary view of an entire image 310 printable on a page of a printing medium. Referring to FIG. 2A, the entire image 310 includes two partial images 320 and 330 provided for the convenience of the following explanation. The entire image 310 may be a single image or may be divided into a plurality of partial images. Within the entire image 310, since there exists only the two partial images 320 and 330 in this example, this indicates that other images besides the two partial images 320 and 330 do not have any information. Alternatively, the cell image generating unit 110 may send to the cell image processing unit 130 only the cell images containing information.

FIG. 2B is an exemplary view of a plurality of cell images created by the entire image dividing unit 112 of the cell image generating unit 110. Referring to FIG. 2B, the partial image 320 is divided into six cell images 321 through 326, and the partial image 330 is divided into four cell images 331 through 334. In this case, the entire image dividing unit 112 may generate cell information for each of the ten cell images 321 through 326 and 331 through 334 when dividing the partial images 320 and 330 into the cell images 321 through 326 and 331 through 334, respectively.

As described above, the cell information may include location or size information of the cell images 321 through 326 and 331 through 334 relative to the entire image 310. For example, if 340 indicates the origin of an x-y coordinate system of the entire image 310, the location information may be coordinate information of predetermined pixels of the cell images 321 through 326 and 331 through 334. If the cell images 321 through 326 and 331 through 334 are formed as squares, as illustrated in FIG. 2B, coordinates of pixels located at each of the four corners of the squares may be location information of the cell images 321 through 326 and 331 through 334. Here, the coordinates of the pixels located at each of the four corners of the squares indicates the size information of the cell images 321 through 326 and 331 through 334 in the entire image 310. The size information may indicate the width and height of the cell images 321 through 326 and 331 through 334. For example, a reference point 350 may indicate a location of a pixel with the highest coordinate among the pixels included in the entire image 310. Alternatively, instead of square or rectangular, the cell images may be polygonal (having more or less than four sides) and the cell information may comprise coordinates of vertices of the polygonal cell image.

The plurality of cell images 321 through 326 and 331 through 334 generated by the entire image dividing unit 112 of the cell image generating unit 110 have the cell information corresponding to each of the plurality of cell images 321 through 326 and 331 through 334, and the cell information obtaining unit 142 of the grouping unit 140 obtains the cell information of each of the cell images 321 through 326 and 331 through 334. The cell image arranging unit 144 arranges the plurality of cell images 321 through 326 and 331 through 334 according to the cell information that the cell information obtaining unit 142 has obtained.

FIG. 2C is an exemplary view of a result of generating group images 327 and 335 by the cell information obtaining unit 142 and the cell image arranging unit 144 by obtaining the cell information of each cell image and arranging the plurality of cell images 321 through 326 and 331 through 334. The cell image arranging unit 144 recognizes the location information of the cell images 321 through 326 and 331 through 334 from the obtained cell information, and arranges the cell images 321 through 326 and 331 through 334 according to the obtained cell information. As a result, the adjacent cell images 321 through 326 and the adjacent cell images 331 through 334 are grouped into group images 327 and 335, respectively. As illustrated in FIG. 2C, the cell image arranging unit 144 generates two group images 327 and 335.

The group image processing unit 150 applies image processing techniques to each of the group images that the cell image arranging unit 144 has generated. An arrow OUT in FIG. 1 indicates the output or printing of the group images that are image processed by the group image processing unit 150.

The group image processing unit 150 recognizes each of the generated group images as one image to be processed, and applies image processing individually to each image separately.

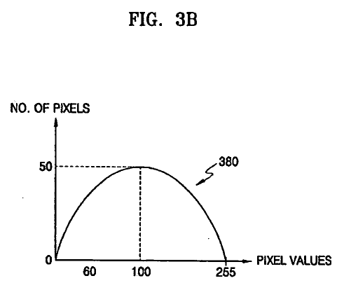

FIGS. 3A and 3B are reference graphs illustrating the image processing conducted by the image processing unit 150 according to an embodiment of the present general inventive concept. FIG. 3A illustrates a pixel histogram 370 before the group image processing unit 150 processes the group images, and FIG. 3B illustrates a pixel histogram 380 after the group image processing unit 150 has processed the group images.

A pixel histogram is a graph illustrating the number of pixels per pixel values, the x-axis representing pixel values and the y-axis representing the number of pixels having a pixel value of the x-axis included in the group images. The pixel value 0 in FIG. 3A indicates a black pixel value, and a pixel value 255 indicates a white pixel value.

As illustrated in FIG. 3A, the group image processing unit 150 has changed the pixel values without changing the rankings in terms of sizes of all the pixel values included in the group image. Here, the group image processing unit 150 can change the pixel value of the brightest pixel among all the pixels included in the group image into a white pixel value and the pixel value of the darkest pixel into a black pixel value. That is, FIG. 3B is a result of expanding the pixel histogram 370 illustrated in FIG. 3A along the x-axis into a predetermined scale ranging from the white pixel value to the black pixel value, for example, the black pixel value being represented by a 0 value and the white pixel value being represented by a 255 value. In other words, each group image may include a plurality of pixels having corresponding pixel values, and the group image processing unit 150 maps the pixel values of the group image to extend an initial range of pixel values to a range between a lowest possible value and a highest possible value.

When printing an entire image generated in a personal computer (PC) after image processing the entire image in the image processing apparatus, the entire image can be divided into a plurality of cell images by an operating system (OS) of the PC. In this case, the cell image generating unit 110 may be the OS. The cell image processing unit 130 may be a printer driver installed in the PC or may be a printer. The cell image generating unit 110 may be referred to as a transmitting side since the cell image generating unit 110 transmits the generated cell images, and the cell image processing unit 130 may be referred to as a receiving side since the cell image processing unit 130 receives the cell images generated at the cell image generating unit 110 and generates the group images, and image processes the group images.

The image processing apparatus of FIG. 1 may further include a printing unit (not shown) to print the group images that are image-processed by the group image processing unit 150 on a predetermined printing medium. The image processing apparatus can be an image forming apparatus. However, the image processing apparatus is not limited to an image forming apparatus and can be embodied in various other devices alternatively.

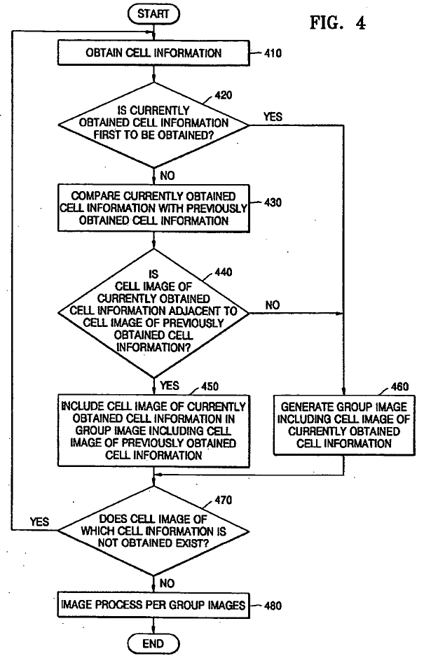

FIG. 4 is a flow chart illustrating an image processing method according to an embodiment of the present general inventive concept. The method includes obtaining cell information (operation 410), arranging cell images (operations 420 through 470), and image processing per group images (operation 480).

The cell information obtaining unit 142 obtains the cell information of a plurality of cell images that are generated by dividing an entire image so that the given entire image is printable on a page of a printing medium (operation 410). The cell information obtaining unit 142 can obtain the cell information of each cell image one by one.

The cell image arranging unit 144 determines whether the currently obtained cell information is cell information obtained for the first time (operation 420). If the currently obtained cell information is cell information obtained for the first time, the cell image arranging unit 144 generates a new group image including the cell image of the currently obtained cell information (operation 460).

If the currently obtained cell information is not obtained for the first time, the cell image arranging unit 144 compares the currently obtained cell information with a previously obtained cell information (operation 430). Here, the cell image arranging unit 144 may compare location information of the currently obtained cell information with location information of the previously obtained cell information. The cell images may be polygons and the cell information may comprise coordinates of vertices of the polygonal cell images.

If the comparison result indicates that the cell image of the currently obtained cell information is adjacent to a cell image of the previously obtained cell information (operation 440), the cell image arranging unit 144 includes the cell image of the currently obtained cell information in a group image including the cell image of the previously obtained cell information (450). In contrast, if the comparison result indicates that the cell information of the currently obtained cell information is not adjacent to a cell image of the previously obtained cell information (operation 440), the cell image arranging unit 144 generates a group image including the cell image of the currently obtained cell information (operation 460).

The cell image arranging unit 144 determines whether there is a cell image of which cell information is not obtained (operation 470). If there is a cell image of which cell information is not obtained, the cell image arranging unit 144 returns to operation 410. However, if cell information of all cell images is obtained, the group image processing unit 150 image processes all the group images per group images (operation 480). The image-processing operations may include changing the pixel values of a group image such that a lowest pixel value among the pixel values of the group image is changed into a lowest possible pixel value and a highest pixel value among the pixel values of the group image is changed into a highest possible pixel value, while maintaining a magnitude order relation between the pixel values of the pixels. For example, each group image may have a plurality of pixels having pixel values corresponding to brightness, and the predetermined image-processing operations includes changing the pixel values corresponding to brightness such that a darkest pixel among the pixel values of the partial image is changed into a black pixel value and a brightest pixel among the pixel values of the partial image is changed into a white pixel value, while maintaining a magnitude order relation between the pixel values corresponding to the brightness of the pixels.

Additionally, the method may include printing each group image as one image on a page of a printing medium and displaying each group image and the entire image.

As described above, an image processing apparatus applying an image processing method can change overall pixel values of a predetermined entire image when the entire image is composed of a plurality of partial images so that the entire image is printable on a page of a printing medium.

The general inventive concept can also be embodied as computer readable codes on a computer readable recording medium. The computer readable recording medium is any data storage device that can store data which can thereafter be read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over a network coupled to the computer systems so that the computer readable code is stored and executed in a distributed fashion.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image processing apparatus, comprising:
a cell information obtaining unit to obtain cell information of each of a plurality of cell images, the cell information including at least location information of each of the plurality of cell images;
a cell image arranging unit to arrange the plurality of cell images according to the obtained cell information, and to generate at least one group image by grouping adjacent cell images together; and
a group image processing unit to perform a predetermined image processing for each group image generated.

2. The image processing apparatus of claim 1, further comprising:
a printing unit to print all of the image-processed group images as one image on a page of a printing medium.

3. The image processing apparatus of claim 1, wherein:
the cell information further comprises size information of the cell images in an entire image, and
the entire image consists of the plurality of cell images.

4. The image processing apparatus of claim 1, wherein the group image processing unit changes pixel values of all pixels included in the at least one group image without changing rankings in terms of sizes of the pixel values.

5. The image processing apparatus of claim 4, wherein the group image processing unit changes a pixel value of a brightest pixel among all the pixels included in each group image generated into a white pixel value, and changes a pixel value of a darkest pixel among all the pixels included in each group image generated into a black pixel value, and expands pixel values of all other pixels included in each group image generated based on the changes performed on the darkest pixel value and the brightest pixel value.

6. An image processing apparatus, comprising:
a cell image generating unit to generate a plurality of cell images by dividing an entire image and to generate cell information including at least location information of each of the cell images; and
a cell image processing unit to arrange the plurality of cell images according to the cell information, to generate at least one group image by grouping adjacent cell images together, and to perform a predetermined image processing for each of the at least one group image.

7. The image processing apparatus of claim 6, wherein the cell image processing unit comprises:
a cell information obtaining unit to obtain the cell information;
a cell image arranging unit to arrange the plurality of cell images according to the obtained cell information, and to generate the at least one group image by grouping the adjacent cell images together; and
a group image processing unit to perform the predetermined image processing for each of the at least one group image.

8. The image processing apparatus of claim 6, further comprising:
a printing unit to print all of the at least one image-processed group image on a printing medium.

9. The image processing apparatus of claim 6, wherein the cell image processing unit changes pixel values of all pixels included in the at least one group image without changing rankings in terms of sizes of the pixel values.

10. An image processing method, comprising:
obtaining cell information including at least location information of each of a plurality of cell images;
arranging the plurality of cell images according to the obtained cell information and generating at least one group image by grouping adjacent cell images together; and
performing a predetermined image processing for each group image generated.

11. The method of claim 10, further comprising:
printing each of the image-processed group images generated as one image on a page of a printing medium.

12. The method of claim 10, wherein the generating of the at least one group image comprises:
determining whether the obtained cell information is first obtained cell information;
comparing the currently obtained cell information to a previously obtained cell information and determining whether a cell image of the currently obtained cell information is adjacent to a cell image of the previously obtained cell information, if the currently obtained cell information is not the first obtained cell information; and
including the cell image of the currently obtained cell information in a group image in which the cell image of the previously obtained cell information is included, if the cell image of the currently obtained cell information is adjacent to the cell image of the previously obtained cell information.

13. The method of claim 12, wherein the generating of the at least one group image further comprises:
generating a group image including the cell image of the currently obtained cell information if the cell image of the currently obtained cell information is not adjacent to the cell image of the previously obtained cell information.

14. The method of claim 10, wherein the generating of the at least one group image comprises:
determining whether the obtained cell information is the first obtained cell information; and
generating a group image including the cell image of the currently obtained cell information if the obtained cell information is the first obtained cell information.

15. The method of claim 12, comprising:
determining whether there is a cell image of which cell information is not obtained; and
returning to the obtaining of the cell information if the there is a cell image of which cell information is not obtained.

16. The method of claim 13, further comprising:
determining whether there is a cell image of which cell information is not obtained; and
returning to the obtaining of the cell information if the there is a cell image of which cell information is not obtained.

17. The method of claim 14, further comprising:
determining whether there is a cell image of which cell information is not obtained; and
returning to the obtaining of the cell information if the there is a cell image of which cell information is not obtained.

18. A computer readable storage medium containing executable codes to perform an image processing method, the method comprising:
obtaining cell information including at least location information of each of a plurality of cell images;
arranging the plurality of cell images according to the obtained cell information and generating at least one group image by grouping adjacent cell images together; and
performing a predetermined image processing for each of the at least one group image
